(19) United States
(12) Patent Application Publication
(10) Pub. No.: US 2021/0016637 A1
(43) Pub. Date: Jan. 21, 2021

(54) AIR OUTLET, MODULE AND AIR OUTLET ASSEMBLY

(71) Applicant: DR. SCHNEIDER KUNSTSTOFFWERKE GMBH, Kronach (DE)

(72) Inventor: Tobias MOECKEL, Burgkunstadt (DE)

(21) Appl. No.: 16/978,646

(22) PCT Filed: Apr. 5, 2019
(86) PCT No.: PCT/EP2019/058670

§ 371 Date: Sep. 4, 2020

(30) Foreign Application Priority Data
Apr. 11, 2018 (DE) 10 2018 108 645.8
Jan. 16, 2019 (DE) 10 2019 101 034.9

(51) Int. Cl. B60H 1/34

(52) U.S. Cl. CPC B60H 1/3421; B60H 2001/3492

(57) ABSTRACT

Disclosed is an air outlet, a module for connecting at least two air outlets, and an air outlet assembly. The air outlet has first and second lateral elements, which are connected to one another via securing elements to form a housing. Different housings can be provided with the corresponding selection of the lateral elements. The slats can be coupled.

An air vent, a module for connecting at least two air vents and an air vent arrangement are described.

### BACKGROUND

Air vents serve for deflection of output air made available by an air-conditioning unit or other ventilating equipment. Air vents are used in vehicles in order to introduce fresh air, temperature-controlled air and/or conditioned air into the passenger compartment of a vehicle. Vehicles can be, for example, motor vehicles such as cars, trucks or buses, trains, aircraft or ships. In the case of air vents, apart from control of deflection of output air from, for example, an air-conditioning unit, it is usually also possible to regulate the amount of output air. The amount of supplied air can be regulated by way of a control device which, for example, is arranged together with a control device for pivotation of slats or separately from such a control device near an outflow opening. The amount of supplied air can be regulated by way of, for example, throttle devices with throttle flaps. Air vents can be arranged in a vehicle dashboard or in the region of the A, B or C pillar or at the roof of a motor vehicle.

### PRIOR ART

Conventional air vents are configured in such a way that they are designed for a specific purpose of use, for example for a specific vehicle type. In addition, air vents within a vehicle, for example along a motor vehicle dashboard, can have different designs, in which case the air vents differ with respect to the shape and design of the housing, the number of air guide elements and the design of throttle devices and screens arranged at the front.

It is therefore necessary to conceive a separate air vent for each individual vehicle type and, moreover, for each position. Substantial costs arise as a result, since the air vents can be made in smaller batches and a separate air vent has to be conceived and produced for each case of use.

The additional outlay then arising leads to high costs and an enormously high expenditure of time. In addition, checking of the outflow performance has to be carried out for each air vent.

### Object

There is accordingly a need for a solution which eliminates the disadvantages of the prior art. In addition, a solution offering universal usability of air vents shall be indicated.

### Solution

The afore-mentioned object is fulfilled by an air vent which comprises at least a housing with two first opposite side elements and two second opposite side elements, wherein
the first side elements and/or the second side elements have fastening elements by way of which the first side elements and the second side elements are connectible together for formation of a housing,
at least one first air guide element is pivotably mountable at the first opposite side elements and/or at least one second air guide element is pivotably mounted at the second opposite side elements, and
at least one first side element and/or at least one second side element has or have at least one connecting section by way of which the air vent is connectible with a first side element and/or a second side element of a further air vent.

It is therefore possible to produce air vents which are made from an appropriate selection of first side elements and second side elements, in which case different side elements are used depending on the respective requirements. These are in that case constructed in such a way that they are connectible together so that production of specific housings is not necessary for every housing type.

Further, in addition an arrangement can also be provided which comprises two air vents or housings which are connected together and which consist of first side elements and second side elements. The air vents themselves can be constructed to be identical or different with respect to the length or width thereof. The housings of the air vents and the further components of the air vents can, in further embodiments, be of substantially identical construction so that these modules together represent a desired arrangement. This makes it possible to use the air vents for different applications and fields of use. For example, the air vents can be arranged adjacent to one another for a vehicle dashboard, in which case the orientation of the individual air vents can be effected by way of the air vents by the connecting sections themselves or the connecting modules indicated in the following. It is therefore possible to arrange several air vents adjacent to one another in a different orientation.

By virtue of the modular mode of construction, air vents which are the same can be used for different vehicle types and kinds. As a result, costs can also be reduced by the modular mode of construction. The use of identical air vents for a multiplicity of vehicles obviously offers many advantages (for example with respect to supply, manufacture, maintenance, tooling, costs, environment, etc.).

Several air vents can be arranged not only alongside one another, but also one above the other. A combination is also possible. Different vent arrangements can thereby be realised.

In addition, a screen or another device can be arranged in front of an arrangement with a plurality of air vents so that the individual air vents or, for example, the housing is or are not visible. This applies in the same manner to connecting modules, which can be concealed.

The at least one first air guide element and/or the at least one second air guide element can be constructed in such a way that these are connectible with a first air guide element and/or a second air guide element of a further air vent.

The connection of the air guide element serves for transmission of a pivot movement over the length and/or height of an arrangement.

A connecting module, which fulfils the afore-mentioned object, for connection of at least two air vents comprises at least two connecting elements by way of which a first side element or a second side element of a first air vent is connectible with a first side element or a second side element of a second air vent by way of the connecting sections.

The connecting elements can be walls or wall sections which bear against the side elements or the side walls of the air vents. However, the connecting elements can also be hooks or similar which, as shown in the figures, engage around a connecting module or receive it therebetween.

The two connecting elements can extend parallel to one another or be inclined relative to one another in a first direction and/or a second direction.

The spacing and/or orientation of the two connecting elements can be settable and/or variable. For example, a connecting module can be adjustable and locking can be carried out after setting has taken place. In addition, the connecting module can have flexible sections so that, for example, a wall or a connecting strut can be compressed or stretched.

A connecting module can comprise a drive device which can be coupled with the first air guide elements and/or the second air guide elements. A drive device can comprise an electronic, electrical, electromechanical or mechanical drive. For example, electric motors, control wheels, control elements at an air guide element, etc., can be provided.

An arrangement fulfilling the afore-mentioned object comprises at least two air vents, wherein the at least two air vents are connected together by way of the connecting sections at first side elements and/or second side elements.

A further arrangement fulfilling the afore-mentioned object comprises at least two air vents and at least one connecting module, wherein first side elements and/or second side elements of the at least two air vents are connected together by way of the at least one connecting module.

An arrangement can comprise a plurality of air vents and connecting modules, wherein two adjacent air vents are connected or connectible together by way of a connecting module.

A coupling can be arranged between the first side walls and/or the second side walls of at least two adjacent air vents and couples together the first air guide elements and/or the second air guide elements of the at least two air vents.

The coupling can comprise a connecting shaft or be formed by a connecting shaft.

The connecting shaft can have a flexible section. The connecting shaft therefore allows a change in the orientation of two adjacent air vents without a special connecting shaft or coupling being required. The connecting shaft or coupling is therefore similarly usable as a modular component for a number of arrangements.

The first air guide elements and/or the second air guide elements can comprise an adapter by way of which the first air guide elements and/or the second air guide elements of the at least two air vents are connectible with one another and/or with the coupling or the connecting shaft. The adapter can, for example, be constructed at an end of a bearing pin of the air guide elements.

The coupling or the connecting shaft can be constructed in such a way that the connection between the first air guide elements and/or the second air guide elements of the at least two air vents is separable or uncouplable. The separation or uncoupling can be carried out under mechanical and/or under electrical or electronic control.

In the case of the arrangement, the transmission of a pivot movement of the air guide elements can be provided by way of all coupled air vents.

All components of such an arrangement of air vents can be used as modular components for different arrangements.

Several first air guide elements and second air guide elements which are coupled together within an air vent can be provided.

In addition, throttle devices such as, for example, closure flaps, of the individual air vents can be coupled together by way of a further coupling or connecting shaft. In addition, at least one drive for throttle devices of that kind can be provided.

The coupling of, for example, second air guide elements can also take place by way of a further coupling device, wherein bearing pins of the air guide elements have a polygonal cross-section and these sections of the bearing pins are received in corresponding openings which are disposed in constituent parts of the coupling device so that transmission of the movement over at least two air vents is possible.

The air vent arrangement in that case provides a system which consists of individual side elements and at least one first and/or second air guide element, wherein a housing is provided that, through selection of the corresponding side elements and air guide elements, is constructed to be adaptable to different requirements. Air guide elements can be, for example, slats or also throttle flaps.

The air vent arrangement can additionally comprise a frame which surrounds an air outlet opening of the housing formed by the side elements. The frame and the first side elements and/or the second side elements have further corresponding fastening elements by way of which the frame is connectible with the housing. Variously constructed frames can therefore be mounted on the housing by way of corresponding fastening elements so that the air vent arrangement is adaptable to different surfaces or sizes or designs.

Moreover, an air vent arrangement can also comprise a throttle device with at least one throttle flap which is pivotably mounted at the opposite first or second side elements. The first or second side elements for that purpose have appropriate bearing openings. Different throttle devices which can be selected in dependence on the configuration of the air vent can then be inserted into the bearing openings.

The first side elements and/or the second side elements can each have at least one further bearing opening, by way of which the at least one first air guide element and/or the at least one second guide element is or are pivotably mounted in the housing.

The air vent arrangement can additionally comprise at least one driving and controlling device for control of the at least one air guide element, the at least one second air guide element and/or the at least one throttle flap. The air vent arrangement can comprise a separate driving and controlling device for each control function or a common driving and controlling device which has at least two control functions for pivoting the at least one first air guide element, the at least one second air guide element and/or the at least one throttle flap.

The driving and controlling device can comprise a lever arrangement, a transmission, a control element, a mechanical coupling device for coupling the at least one first air guide element and the at least one second air guide element and/or an electric motor. A control element can be, for example, a control wheel, control lever or similar. A lever arrangement can serve for pivotation of air guide elements and/or throttle flaps. Transmissions can translate rotational movements and be coupled with further devices such as, for example, a control wheel or another control element. Mechanical coupling devices for coupling the movement of different control functions can serve, for example, the purpose of pivoting not only first air guide elements, but also second air guide elements by way of a control element. The one control element can in that case be in contact with an electric motor so that the activation of two different air guide elements can be achieved by way of a single electric motor. Such a coupling device can, for example, be constructed as defined in German Patent DE 10 2015 101 101 B3 of the Applicant. The coupling device can in that case also serve the purpose of activating two adjacent air vent arrangements with an individual drive unit (for example electric motor), wherein the activation can take place independently or also in common. A drive device, which is provided for that purpose, for adjusting at least two air guide elements by means of a drive unit, such as, for example, an electric motor, can comprise a drive unit in the form of an electric motor, a guide element, a transfer unit and a gate guide arrangement with several guide tracks, wherein the transfer unit is coupled with the drive unit (electric motor) and with the guide element and wherein the guide tracks are connected together and have sections with openings in which displacing elements of a first displacing element and a second displacing element are displaceably received. The guide element can be displaced along the guide tracks against the force of a first spring device, in which case the first displacing element is coupled with at least one air guide element and the second displacing element is coupled with at least one second air guide element.

Instead of air guide elements being coupled, coupling of throttle devices can also be effected. It is also possible to activate at least one first guide element and at least one second guide element by way of a drive device constructed in such a way with an individual electric motor.

The first side elements, the second side elements, the at least one first air guide element, the at least one second air guide element, the screen, the driving and controlling device and/or the throttle device can be selectable from a quantity of first side elements, second side elements, first air guide elements, second air guide elements, screens, driving and controlling devices and/or throttle devices, in which case the individual components are connectible with and exchangeable for one another.

The components can differ with respect to the length, width, thickness, material, number of bearing openings, configurations of driving and controlling devices, configuration of the throttle devices and/or the external form.

The air vent arrangement makes it possible to provide different air vents by selection of appropriate components. By comparison with known constructions of air vents there is the advantage that a completely new concept does not have to be developed and provided for different housings and air vent types, but the concept can be realised from a number of different components depending on the required configurations. In addition, the visual appearances of the air vent arrangements can be appropriately selected by way of the screens. The housings are composed of an appropriate number of different first side elements and second side elements. The number of air guide elements can be selected as desired, in which case for that purpose there is selection of appropriate side elements having an appropriate number of bearing openings for the air guide elements. The same applies to the driving and controlling devices, which are selected in correspondence with the desired construction. In that regard, it is possible to draw on a number of different components. For example, electric-motor drives and/or mechanical drives can be selected. In addition, by virtue of the modular construction of the components the controlling and driving devices can be arranged not only on the lefthand, but also on the righthand side as well as above or below at a housing of the air vent.

The modular principle of the air vent arrangement ensures that air vents for a wide field of use can be produced from one range of components. Separately matched housing types and air vents themselves are therefore no longer required. Moreover, the necessary expenditure of time and necessary costs can be enormously reduced.

The technical teaching described herein offers the possibility of modular construction of housings for air vents as well as of air vents themselves and of connecting at least two air vents together, in which case, moreover, use can be made of substantially identically constructed air vents for different applications, in which the arrangement and orientation of the air vents relative to one another is different.

This is achieved by the modular mode of construction of the air vents. For that purpose, the air vents can have side elements which are connectible together. The connection of the air vents can be carried out in such a way that the side elements, which are constructed as, for example, side walls, bear directly against one another or extend parallel to one another or that the side elements have an arrangement inclined relative to one another.

The inclined arrangement relative to one another can be effected by modules which, as connecting modules, connect two adjacent air vents with one another.

However, it is also possible for the connection of the air vents to be undertaken by way of connecting sections at the side elements (first side elements and/or second side elements).

The connecting sections can be in all variants, for example detent elements, pins, hooks, insertion openings as well as general connecting means. In further embodiments, side walls or the side elements themselves can serve as connecting sections.

Further advantages, features and possibilities of embodiment are evident from the following description of figures of embodiments, which are to be understood as non-limiting.

### BRIEF DESCRIPTION OF THE DRAWINGS

In the drawings:

FIG. 1 shows different perspective illustrations of an air vent of modular construction, in accordance with the modular system;

FIG. 2 shows perspective illustrations of different couplings for air vents, in accordance with the modular system;

FIG. 3 shows a perspective illustration of an air vent arrangement with two air vents, a connecting module between the air vents and decorative strips, in accordance with the modular system;

FIG. 4 shows an exploded perspective illustration of an air vent arrangement with two air vents, a connecting module between the air vents and a connecting element, in accordance with the modular system;

FIG. 5 shows a perspective illustration of an air vent arrangement with two air vents and a connecting module between the air vents, in accordance with the modular system;

FIG. 6 shows a perspective illustration of a further air vent arrangement with two air vents and a connecting module between the air vents, in accordance with the modular system;

FIG. 7 shows a perspective illustration of yet another air vent arrangement with two air vents and a connecting module between the air vents, in accordance with the modular system;

FIG. 8 shows different perspective illustrations of an air vent arrangement of yet a further form of embodiment with two air vents and a connecting module between the air vents, in accordance with the modular system;

FIG. 9 shows a perspective exploded illustration of an air vent arrangement with two air vents, a connecting module between the air vents and further components, in accordance with the modular system; and

FIG. 10 shows a further perspective, exploded illustration of the air vent arrangement of FIG. 9.

In the drawings, elements provided with the same reference numerals substantially correspond with one another insofar as nothing to the contrary is indicated. Moreover, illustration and description of components which are not significant for understanding the technical teaching disclosed herein are dispensed with. Further, the reference numerals are not repeated for all already introduced and illustrated elements insofar as the elements themselves and the function thereof have already been described or are known to an expert.

### EXPLANATORY DESCRIPTION OF EMBODIMENTS

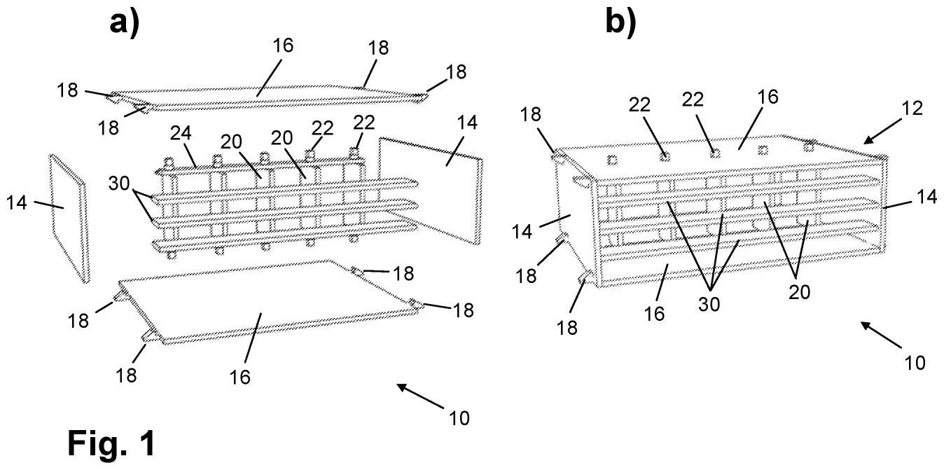

FIGS. 1 to 10 show different illustrations and views of air vents, air vent arrangements and components of these arrangements as well as the air vents according to the modular system described herein. The modular system for an air vent arrangement, which can even comprise only a single air vent 10, 11 having at least two first side elements and two second side elements, wherein the side elements form side walls 14, 16, is defined by the fact that the first side elements and the second side elements can be respectively arranged oppositely for formation of a housing 12. In addition, the first side elements and the second side elements have corresponding fastening elements 18, by way of which the first side elements are connectible with the second side elements. Instead of the side elements 18, which are constructed as hooks, shown in the figures, fastening elements 18 can also be of different construction. Fastening elements can also be formed by fastening or contact surfaces. The modular system is further defined by the fact that at least one first air guide element can be pivotably arranged between the opposite first side elements and/or at least one second air guide element can be pivotably arranged between the opposite second side elements. Moreover, the modular system comprises, for selection, at least two different first side elements and/or at least two different second side elements, wherein the first side elements and/or the second side elements can be selected in accordance with the number and/or form of the at least one first guide element and/or the at least one second guide element as well as the requirements of the air vents 10, 11 or the air vent arrangement 100.

FIG. 1 shows different perspective illustrations of an air vent 10 of modular construction in accordance with the modular system. FIG. 1a) shows the individual components of the housing 12 in an exploded illustration as well as the slats 20 and 30, wherein the slats 20 are coupled together by way of entrainers 24. In the illustrated form of embodiment of FIG. 1, the slats 20 are pivotably mounted by way of the bearing pins 22 thereof between the side elements 16, for which purpose the side walls 16 have corresponding bearing openings. In addition, the slats 30 are mounted between the opposite side walls 14. As a result, not only the slats 20, but also the slats 30 are received in the housing 12 in the embodiment. In further embodiments (not illustrated) an arrangement with slats 20 or slats 30 can be received in one such housing 12 and a further arrangement of slats 30 or slats 20 in a further housing, in which case the individual housings, which then function as modules, are connectible together. In that regard, the sequence of the arrangement is not predetermined, so that a module with slats 20 can be arranged in front of or behind a module with slats 30. Instead of slats 20 and 30, other guide elements can also be arranged in the corresponding modules or the housing 20. The connection of the modules with one another—wherein a further module for a throttle device and a screen also count for that purpose—can be effected by way of appropriate fastening elements which are provided and constructed similarly to the fastening elements 18.

In the embodiment of FIG. 1 the fastening elements 18 serve the purpose of connecting the side walls 14 and 16 together. In that respect, in the embodiment only the side walls 16 have fastening elements 18 constructed as hooks. The side walls 14 have contact surfaces for the fastening elements 18. These contact surfaces then similarly serve as fastening elements. In further forms of embodiment (not illustrated) the side walls 14 can also have corresponding hooks or other fastening elements. In addition, the construction of the fastening elements 18 is not restricted to the hook-shaped design such as shown in the figures. Other hook arrangements can also be provided.

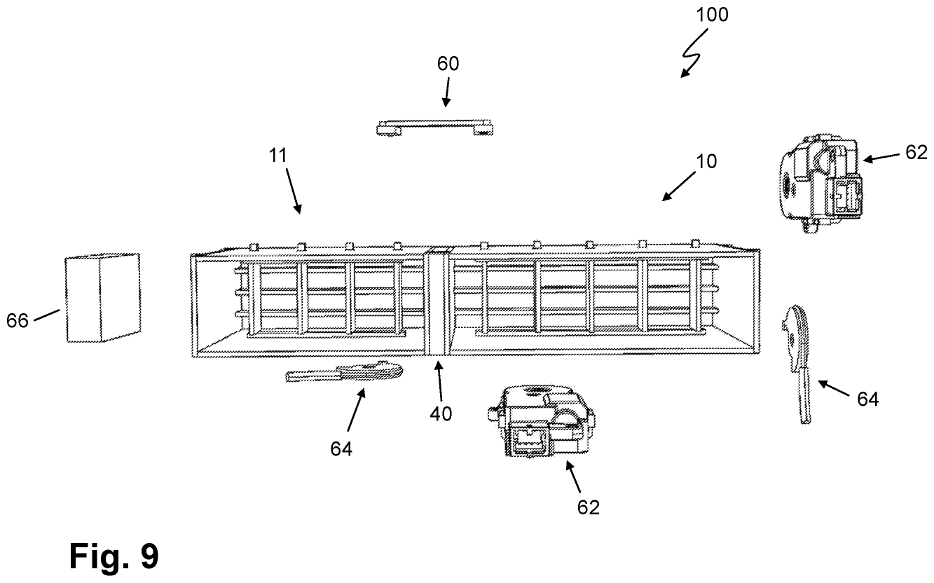

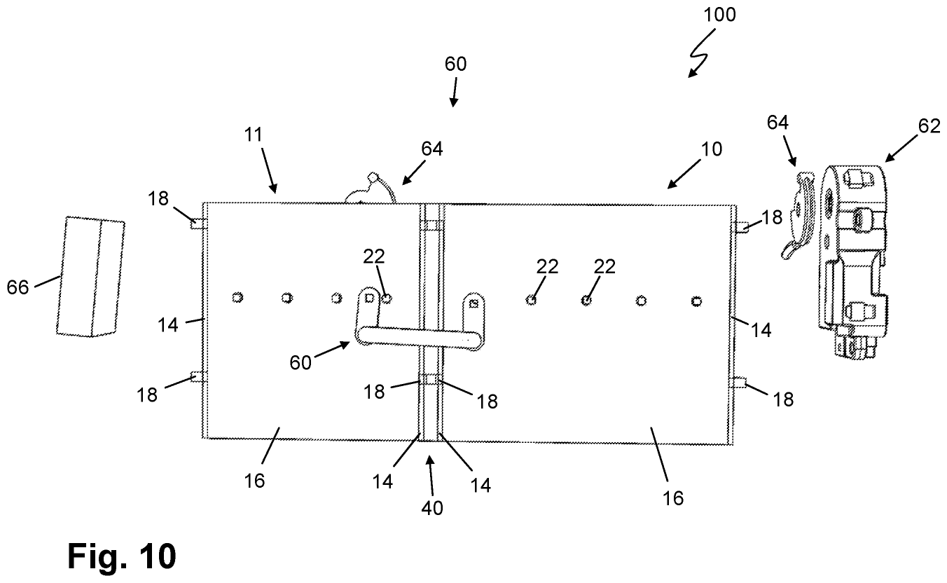

Moreover, the illustration of the individual side walls 14 and 16 is schematic in nature. In forms of embodiment which are not illustrated the side walls can be formed to be curved or have bent sections. In addition, the form of the side walls 14 and 16 can be different overall. The side elements 14, 16 can also have stiffening structures. In addition, openings for the bearing pins 22, in which these are pivotably mounted, are provided. As schematically shown in FIG. 1b, the bearing pins 22 can project through the openings and have a corresponding section with a profile. The profile can be formed by a corresponding cross-section of the bearing pin 22. It is possible by way of that to couple the bearing pins together via a transmission element 60, which is shown in FIGS. 9 and 10, so that the slats 20 of two adjacent air vents 10, 11 can be pivoted synchronously with one another. Moreover, the slats 22 are so coupled together by way of coupling rods that the pivotation of one slat 20 causes synchronous pivotation of the other slats 20.

FIG. 1b) shows the air vent 10 in assembled state of the side walls 14 and 16, whereby a housing 12 is realised. The slats 20 and 30 are mounted between the opposite side walls 14 and 16.

The components of the air vent 10 can consist of plastics material and can therefore be produced simply and economically in high numbers in an injection-moulding process. Different plastics material can be combined to form an element or further components with other mechanical properties can be attached to an element in a multi-component injection-moulding process.

The side walls 14 and/or 16 can have a connecting section which serves for fastening a side wall 14, 16 of an air vent 10, 11 to a further side wall 14, 16 of a further air vent 10, 11. Two side walls 14, 16 of adjacent air vents 10, 11 can be directly connected together by way of this connecting section. However, it is also possible for these connecting sections to additionally or alternatively enable connection with connecting modules 14 which are provided for connection of the air vents 10, 11. For that purpose, the connecting sections can have fastening elements constructed in correspondence with the fastening elements 18. In further forms of embodiment the fastening elements 18 can also function as fastening elements of the connecting sections. It is to be noted that the fastening elements of the connecting sections, just like the fastening elements 18, are not limited to the illustrated form of embodiment.

FIG. 1 shows an embodiment with an air vent 10 of modular construction, which has side walls 16 serving for mounting of five slats 20. If an air vent is to have fewer slats, then instead of the side walls 16 use can be made of other side walls 16 which are of appropriately shorter or longer construction. In addition, instead of the side walls 14 use can be made of higher or lower or longer or shorter side walls 14. In addition, the depth of the side walls 14 and 16 can be selected in correspondence with the construction of the components for air deflection and the form of the housing 12 as well as the air vent 10, 11. In that case, the fastening elements 18 as well as the side walls 14 and 16 are of such a configuration that the different side walls 14 and 16 are connectible together regardless of their corresponding length or shape.

A thus-constructed base unit can therefore be provided in several sizes and widths. In particular, the housing 12 and the slats 20 and 30 are individual modules which are not design-independent and thus enable use for different air vents 10, 11. In particular, the individual components such as, for example, the side walls 14, the side walls 16, the slats 20 and the slats 30 can be constructed as common parts. Such an air vent 10 with the housing 12 can be mounted in, for example, a screen, a support, a switch panel, a centre console and so forth. The housing 12, which is arranged behind these elements, does not have any effect on the design. The design of the air vents is fixed by way of the screens or supports, switch panels, centre consoles, etc., mounted in front.

As already described, in addition several basic modules, which consist of, for example, elements such as shown in FIG. 1, can be joined together to form a basic module chain. For that purpose, connection of the air vents 10, 11 directly together with the help of a connecting module (see in that respect connecting module 40) can be effected. The extension and construction can be carried out in accordance with requirements. In particular, connecting modules for so-called H slats (for example slats 20) and/or also closure flaps can be provided. These connecting modules can be constructed as, for example, screens which are mounted on the front side of the housing 12 so that a specific visual design is achieved by way of the screen. The slats 30 can, for example, be mounted in this design part, which is similarly constructed as a module. The slats 30 can similarly be pivotable or fixed, non-pivotable slats 30. Finally, a further module with a closure flap arrangement or another throttle device can be mounted between a front screen/design module and the housing 12 or behind the housing 12. The connection of the individual modules with one another can be effected by way of further fastening elements provided at the corresponding modules. These fastening elements can be constructed analogously to the fastening elements 18 and the fastening elements of the connecting sections. In further forms of embodiment, which are not illustrated, individual fastening elements of the different embodiments can take over the function for two or three different tasks.

In the case of a basic module chain provided by an air vent arrangement 100 a connecting module 40 can be an angled connecting module so that two adjacent air vents 10, 11 have a different orientation relative to one another. Standardised place-holder connecting modules, which are of different width and which are represented in the figures by the connecting module 40, can comprise further elements or serve for mounting and holding further elements. Such elements can be, for example, a clock, a warning flasher switch, a control wheel, etc. These elements can then be integrated in a screen arranged at the air outlet opening of the housing 12.

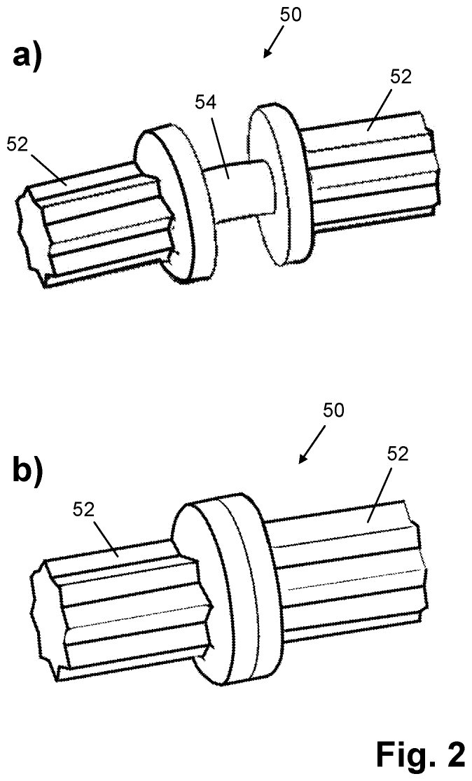

FIG. 2 shows perspective illustrations of different couplings for air vents 10, 11 according to the modular system. The couplings 50 serve for transmission of the rotation of a slat group with slats 30 and/or 20 to a further slat group with slats 20, 30 of an adjacent air vent 10, 11. In addition, the coupling 50 serves the purpose of transmitting the rotational movement of a drive element, such as a drive unit 62 or a control wheel 64 to a further unit or to a group of slats 20, 20.

FIG. 2a) shows the construction of a coupling 50 with two coupling adapters 52 having a star-shaped profile. This star-shaped profile engages in a corresponding receptacle of a connecting element of a slat 20, a slat 30, a control wheel 64, a drive unit 62 or another unit. A shaft 54 connects the two coupling adapters 52. The shaft 54 can be, in particular, of flexible construction so that transmission of rotation is possible, wherein the coupling adapters 52 can have a different orientation relative to one another. This is advantageous particularly in the case of air vents 10, 11 arranged at an angle relative to one another and/or drive elements or further units arranged at an angle with respect thereto. In particular, angle compensation between individual air vents 10, 11 can be achieved by way of the shaft 54. The shaft 54 can for that purpose be torsionally stiff or, however, flexible in bending. A double-ended coupling adapter 52 for an actuator or an air guide element such as, for example, the slats 20, 30, is thus possible. The length of the shaft 54 can be dependent on the design. For example, a shaft 54 can bridge over a clock, a warning flasher switch, a cup holder, etc., between two adjacent air vents 10, 11, for example behind the connecting module 40. The coupling adapters 52 in further forms of embodiment (not shown) can be constructed as male or female adapters. The length of the shaft 54 is in that case dependent on the distance to be bridged over. In further forms of embodiment a coupling 50 can be electronically controlled so that separation and connection of adjacent air vents 10, 11 and/or drive units is possible.

FIG. 2b) shows a further embodiment of a coupling 50, which is constructed as the shortest coupling part so as to, for example, keep the spacing between two adjacent air vents 10, 11 as small as possible. In that case, slats 20, 30 can directly adjoin one another.

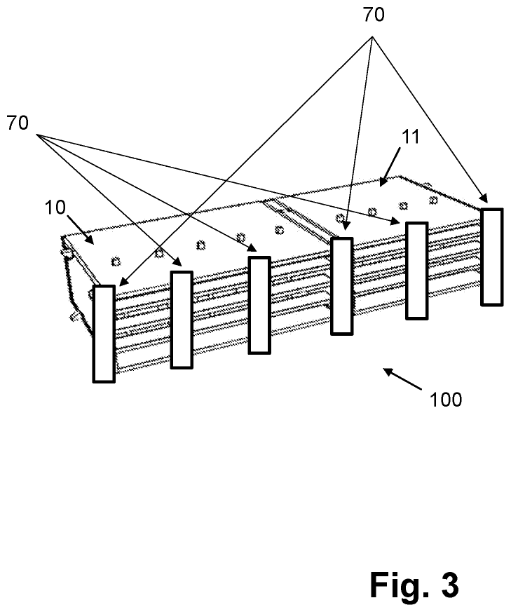

FIG. 3 shows a perspective illustration of an air vent arrangement 100 with two air vents 10, 11, a connecting module 40 between the air vents 10, 11 and decorative strips 70 in accordance with the modular system. The decorative strips 70 serve the purpose of covering connecting elements such as, for example, the connecting module 40 and the side walls 14. The decorative strips 70 can be constructed as decorative strips, screens or other decorative elements. The decorative strips 70 can be constructed to be design-dependent and can, moreover, possibly hide different spacings at air vents 10, 11 or between air vents 10, 11. The decorative strips 70 can for that purpose have fastening elements which enable direct coupling to the base modules, thus the housing 12, or to upstream modules such as, for example, screen units, etc. These fastening elements can be constructed analogously to the already described fastening elements.

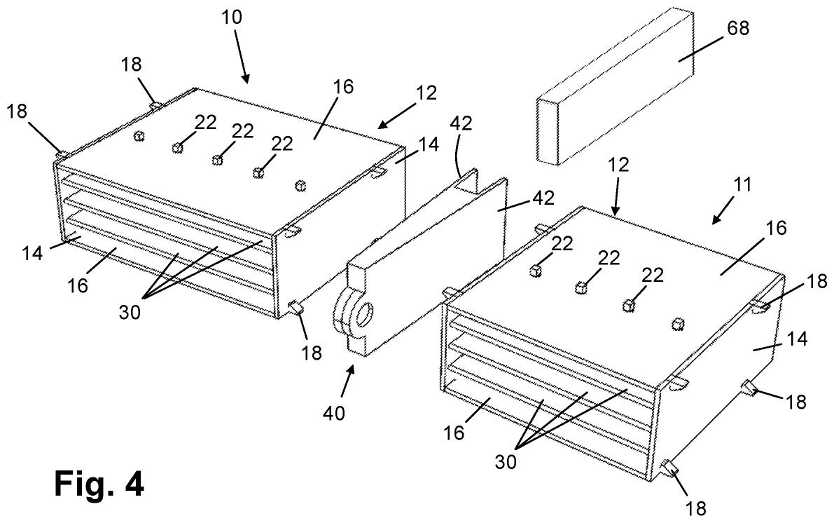

FIG. 4 shows a perspective exploded illustration of an air vent arrangement 100 with two air vents 10, 11, a connecting module 40 between the air vents 10, 11 and a connecting element 68 in accordance with the modular system. The connecting module 40 has two walls 42 which are inclined relative to one another so that the orientation of the two air vents 10, 11 is settable in defined manner by way of the connecting module 40. The connection of the air vents 10, 11 or the housings 12 is effected by way of the fastening elements 18 of the side walls 16, which provide a fastening to the walls 42. The connecting element 68 can be mounted between a side wall 14 and a wall 42 or at a side wall 14 and be connected by way of the fastening elements 18 with the side walls 14. For that purpose, the walls 42 can also have fastening elements which are constructed analogously to the fastening elements 18 so that the connecting element 68 is directly connectible with the connecting module 40 and at the opposite side with a corresponding wall 14. In further forms of embodiment (not illustrated) the connecting element 68 can also have corresponding fastening elements 18 which enable connection with the wall 42 and the side wall 14. The connecting element 68 can be provided for reception of an actuator for a drive of the adjacent air vents 10, 11. Alternatively, the connecting element 68 can also be understood as an actuator which serves for common or separate activation of the individual movement-capable components of the air vents 10, 11.

Several basic modules can also be joined together, for example, by way of connecting modules 40 and/or connecting elements 68 to form a basic module chain, wherein this basic module chain is subsequently spanned by an overall screen for an air vent or the like. The screen of the air vent arrangement is in that case fixedly connected with the housings 12.

The connecting module 40 can be constructed as a plastics-material injection-moulded part and can therefore be similarly produced economically in large numbers. The connecting module 40 can have different receptacles at the front side so that, for example, a clock, a cup holder or displaying and switching means can be mounted and supported by way of that. The width and configuration of the corresponding connecting modules 40 in that case depends on the respective purpose of use and the design. In that regard, different connecting modules 40 which are selected in correspondence with the desired requirements and course of the basic module chain can be provided.

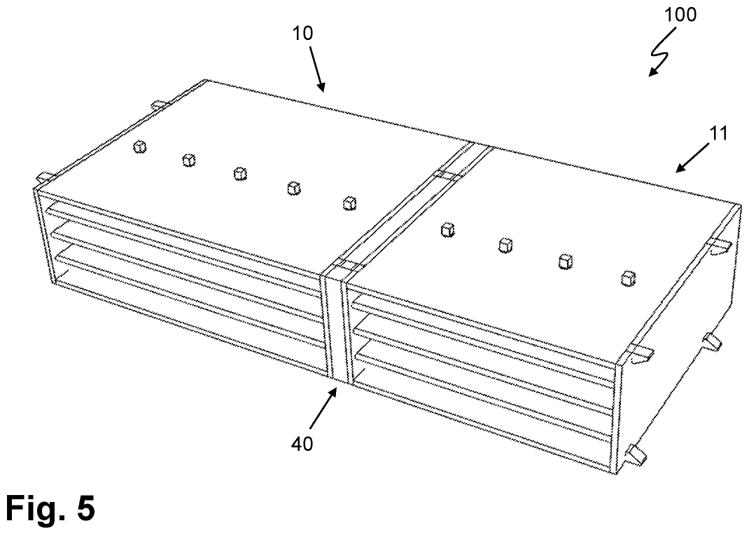

FIG. 5 shows a perspective illustration of an air vent arrangement with two air vents 10, 11 with a connecting module 40 between the air vents 10, 11 in accordance with the modular system. FIG. 5 shows an embodiment in which the air vents 10, 11 are substantially so arranged relative to one another that the opposite side walls 14 extend parallel to one another.

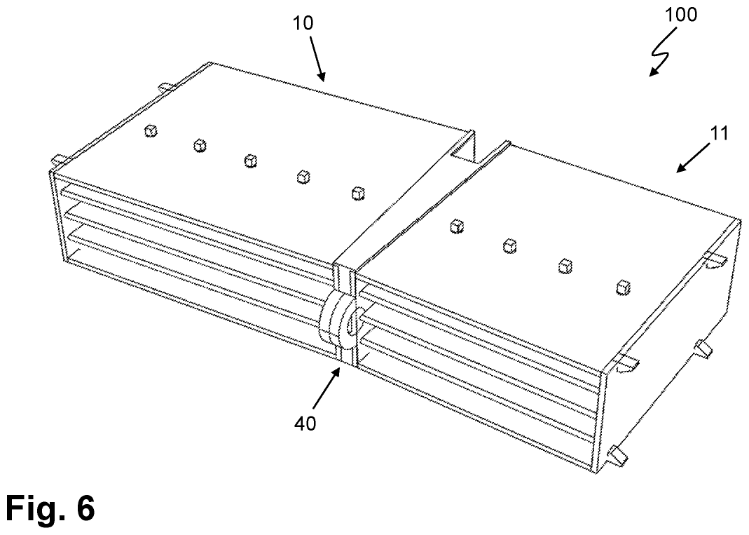

FIG. 6 shows a further embodiment, wherein the two air vents 10, 11 are arranged at an angle relative to one another by way of a correspondingly constructed connecting module 40. In that regard, the two air vents 10, 11 are inclined relative to one another about an axis extending parallel to the pivot axes through the bearing pins 22.

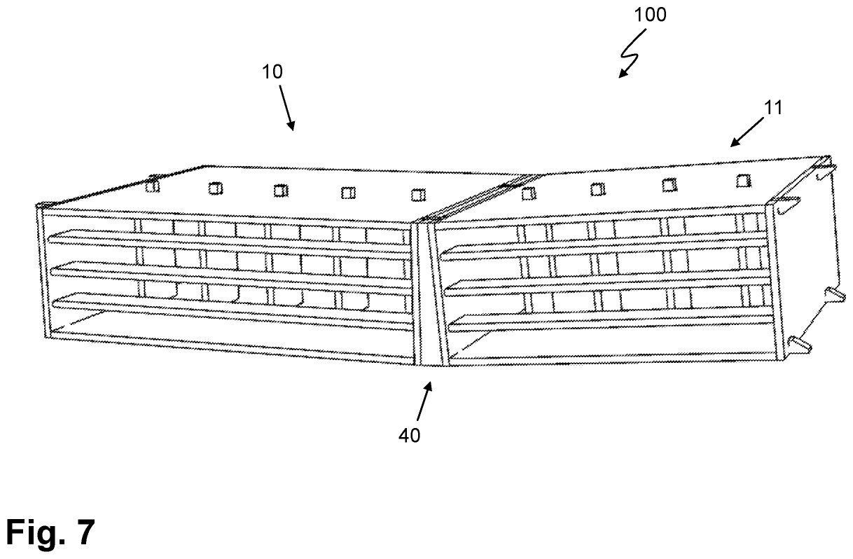

FIG. 7 shows yet a further form of embodiment of an air vent arrangement 100, wherein the air vents 10, 11 are arranged at an angle relative to one another by way of a corresponding connecting module 40, in which case the air vents 10, 11 are inclined relative to one another about an axis extending orthogonally to the pivot axis through the bearing pins 22.

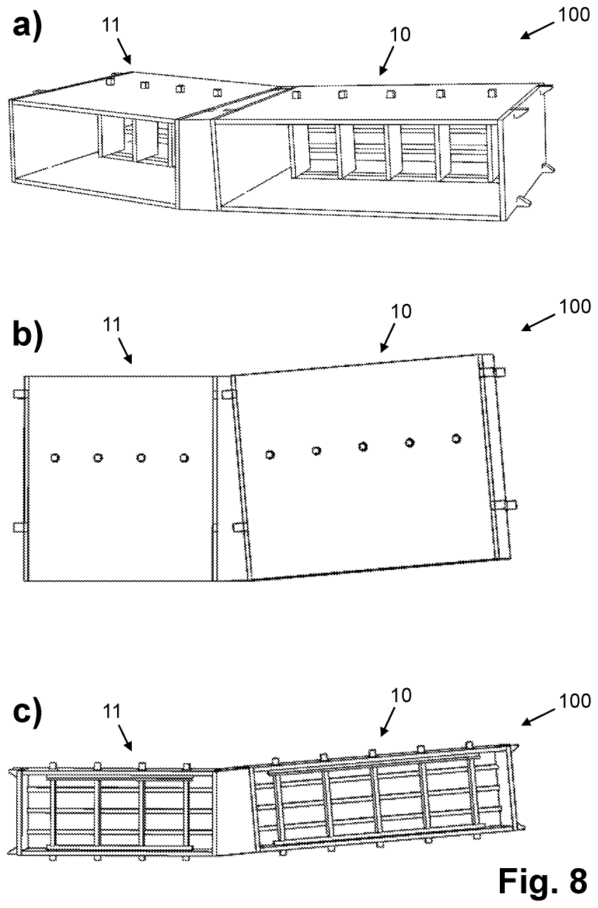

FIG. 8 shows different perspective illustrations of an air vent arrangement 100 according to yet a further form of embodiment with two air vents 10, 11 and a connecting module 40 between the air vents 10, 11 in accordance with the modular system, wherein the air vents 10, 11 are pivoted not only about an axis extending parallelly through the pivot axis of the slats 20 by way of the bearing pins 22, but also about an axis extending orthogonally thereto.

FIG. 8a) in that case shows a perspective illustration of the rear side of the air vents 10, 11, by way of which either a further module, for example a closure flap module, is connectible with the housings 12 or an air channel can be directly connected by way of corresponding fastening elements.

FIG. 8b) shows a plan view of the air vent arrangement 100 and FIG. 8c shows a further view of the rear side of the air vent arrangement 100, which is opposite the air outlet opening.

It is possible to achieve several angles through different connecting modules 40 and thus arrangements of the air vents 10, 11 by variants of the adapter modules or connecting modules 40. It is possible by way of appropriate selection of the connecting modules 40 to follow a three-dimensional contour which, in particular, is useful for providing so-called wide-band air vents which extend, for example, substantially over the entire length of a dashboard. Straight or parallel constructions of connecting modules are also possible. In further forms of embodiment, angles in the vertical plane (inclined upwardly or downwardly), angles in the horizontal plane (inclined forwardly or rearwardly) and/or free angles (spatial offset of the connecting planes) can be achieved by way of appropriate connecting modules 40.

In yet further forms of embodiment (not illustrated) variants of the connecting modules 40 which enable compensation for angle and tolerance are possible. In addition, it is possible to achieve, by way of a joint or film hinge, a setting of the orientation of two adjacent air vents 10, 11 via an appropriately constructed connecting module with a joint of that kind. The connecting module 40 can in that case also take up predetermined detent settings. In still further forms of embodiment a flexible decoupling of the side walls 14 is therefore possible.

In further forms of embodiment two fixed side walls 14, 16 for a single air vent 10, 11 with flexible connecting modules 40, which, for example, are constructed as domes between the side walls 14, 16, are provided. A freely settable offset of the air vents 10, 11 relative to one another is possible by way of that.

In further forms of embodiment (not illustrated) air vents can also be connected together by way of the side walls and combined to form an air vent arrangement 100. For that purpose, use can similarly be made of appropriately constructed connecting modules. In further forms of embodiment, air vents 10, 11 can also be directly connected together by way of the side walls 16, 14 thereof. An air vent arrangement 100 can therefore comprise several air vents 10, 11 which are arranged not only substantially alongside one another, but also one above the other.

As shown in the figures, the air vents 10, 11 have a construction different from one another, wherein the air vent 10 has such a width that five slats 20 can be mounted therein at substantially the same spacing from one another. In the case of the air vent 11, merely four slats 20 are arranged alongside one another, so that the width of the air vent 11 is smaller than the width of the air vent 10. However, the air vents 10, 11 have identically constructed side walls 14. Merely the side elements 16 are of different construction.

FIG. 9 shows a perspective exploded illustration of an air vent arrangement 100 with two air vents 10, 11, a connecting module 40 between the air vents 10, 11 and further components. The further components comprise a transmission element 60 which, as better illustrated in detail in FIG. 10, has arms each with an opening which corresponds with the cross-section of the bearing pins 22. The bearing pins 22 can be received in these openings and are therefore coupled with the arms of the transmission element 60 to be secure against relative rotation. The arms of the transmission elements 60 are coupled together by way of a coupling rod so that the pivotation of the slats 20 of an air vent 10 automatically also produce a synchronous pivotation of the slats 20 of the air vent 11 and conversely. In addition, drive units 62 and control wheels 64, which serve for pivotation of the slats 20 and 30, are illustrated. The drive units 62, which are constructed as an actuator and can comprise an electric motor, wherein a remotely controlled operation is possible, can be provided either alternatively or in common. It is thus possible to not only pivot the slats 20, 30 by way of an electronic control, but also to undertake manual pivotation.

The lighting unit 66 is similarly constructed as a module and can be mounted on a side wall 14 by way of corresponding fastening elements 18. It is possible through the modular construction to mount the lighting unit 66 on the side walls 14 of the air vent 10 or on the side elements 14 of the air vent 11. In addition, in the case of a connecting module of appropriately wide construction it is possible to arrange the lighting unit 66 between the side walls 14 of the adjacent air vents 10, 11.

The transmission element 60 can be present in different widths so that transmission of the rotation over air vents 10, 11 with correspondingly wide or close spacing is possible.

The side walls 14, 16 comprise the fastening elements 18 as well as connecting sections with corresponding fastening elements, by way of which the drive units 62 and the control wheels 64 can also be mounted. In still further forms of embodiment the side walls 14, 16 can have additional fastening elements serving for reception of the drive units 62 and the control wheels 64, so that special side walls 14, 16 are not required, but either a drive unit 62 in the form of an actuator with a motor or a control wheel 64 can be mounted according to the desired configuration. Accordingly, the side walls 14, 16 also have coupling points such as, for example, passage openings, etc., by way of which the slats 20, 30 are accessible from outside. In particular, it is possible to also use for that purpose couplings 50 which engage in corresponding openings in the slats 20, 30 and are connectible with the drive units 62 or the control wheels 64. In that regard, FIGS. 9 and 10 schematically show that the drive units 62 and the control wheels 64 have openings which are formed in correspondence with the coupling adapters 52.

Mechanical/electrical drive modules (drive unit 62, control wheel 64) can be added. Transmission of the movement is possible by way of the transmission element 60. In addition, presentation of light is possible and further control modules (such as, for example, control wheels 64) can be plugged on.

Moreover, a corresponding adjustment can be predetermined by way of the control wheels 64, wherein the control wheels 64 are electrically coupled with the drive units 62 so that these execute, by way of the control wheels 64, predetermined pivotations via an appropriate activation. The side walls 14, 16 can therefore also be constructed so that not only drive units 62, but also control wheels 54 can be provided.

The configuration of the connecting modules 40 is selectable in correspondence with requirements. In that case, use can also be made of extremely flat connecting modules 40 so that slats can directly adjoin one another.

In further forms of embodiment, driving and controlling devices for control of the slats 20, 30, control of the throttle flap or control of other elements can also be provided. The driving and controlling devices can comprise a lever arrangement, a transmission, a control element, a mechanical coupling device for coupling the slats 20 and 30 and/or an electric motor. In particular, the slats 20, the slats 30, a screen, a screen module, a driving and controlling device and/or a throttle device as well as a throttle module can be selectable from at least two first slats 20, two second slats 30, two screens or screen modules, two driving and controlling devices and/or two throttle devices, wherein the individual components are connectible with and exchangeable for one another.

The components can also differ with respect to the length, width, thickness, material, number of bearing openings, construction of the driving and controlling device, construction of the throttle devices and/or the external shape.

Moreover, the spacing and/or the orientation of two side walls 14, 16, which are connected together by way of a connecting module 40, can be settable and/or variable. In that case, in particular, the walls 42 can be settable and/or variable in the orientation and spacing thereof.

The modular system makes it possible to provide air vents 10, 11 as well as air vent arrangements 100 in which individual modules able to be connected together are produced.

### REFERENCE NUMERAL LIST

10 air vent
11 air vent
12 housing
14 side wall
16 side wall
18 fastening element
20 slat
22 bearing pin
24 entrainer
30 slat
40 connecting module
42 wall
50 coupling
52 coupling adapter
54 shaft
60 transmission element
62 drive unit
64 control wheel
66 lighting unit
68 connecting element
70 decorative strip
100 air vent arrangement

1. An air vent for vehicles, comprising a housing with two first opposite side elements and two second opposite side elements, wherein
the first side elements and/or the second side elements have fastening elements by way of which the first side elements and the second side elements are connectible together for formation of a housing,
at least one first air guide element is pivotably mountable at the first opposite side elements and/or at least one second air guide element is pivotably mountable at the second opposite side elements, and
at least one first side element and/or at least one second side element has or have at least one connecting section by way of which the air vent is connectible with a first side element and/or a second side element of a further air vent.

2. The air vent according to claim 1, wherein the at least one first air guide element and/or the at least one second air guide element is or are so constructed that these are connectible with a first air guide element and/or a second air guide element of a further air vent.

3. A connecting module for connecting at least two air vents as claimed in claim 1, said connection module comprising two connecting elements by way of which a first side element or a second side element of a first air vent is connectible with a first side element or a second side element of a second air vent (10; 11) by way of the connecting sections.

4. The connecting module according to claim 3, wherein the second connecting elements are parallel or inclined in a first direction and/or a second direction relative to one another.

5. The connecting module according to claim 3, wherein the spacing and/or orientation of the two connecting elements is or are settable and/or variable.

6. The connecting module according to claim 3, comprising a drive device which can configured to be coupled with the first air guide elements and/or the second air guide elements.

7. An arrangement comprising at least two air vents as claimed in claim 1, wherein the at least two air vents are connected together by way of the connecting sections at first side elements and/or second side elements.

8. The arrangement comprising at least two air vents as claimed in claim 1 and at least one connecting module, comprising two connecting elements by way of which first side element or a second side element of a first air vent is connectable with a first side element or a second side element is a second air vent by way of the connecting sections wherein first side elements and/or second side elements of the at least two air vents are connected together by way of the at least one connecting module.

9. The arrangement according to claim 7, wherein arranged between the first side walls and/or the second side walls of at least two adjacent air vents is a coupling configured to couple the first air guide elements and/or the second air guide elements of the at least two air vents together.

10. The arrangement according to claim 9, wherein the coupling comprises a connecting shaft or is formed by a connecting shaft.

11. The arrangement according to claim 10, wherein the connecting shaft has a flexible section.

12. The arrangement according to claim 7, wherein the first air guide elements and/or the second air guide elements comprise an adapter by way of which the first air guide elements and/or the second air guide elements of the at least two air vents are connectible with one another and/or with the coupling or the connecting shaft.

13. The arrangement according to claim 9, wherein the coupling or the connecting shaft is so constructed that the connection between the first air guide elements and/or the second air guide elements of the at least two air vents is separable.

14. The arrangement according to claim 8, wherein arranged between the first side walls and/or the second side walls of at least two adjacent air vents is a coupling configured the couple the first air guide elements and/or the second air guide elements of the at least two air vents together.

15. The arrangement according to claim 14, wherein the coupling comprises a connecting shaft or is formed by a connecting shaft.

16. The arrangement according to claim 15, wherein the connecting shaft has a flexible section.

17. The arrangement according to claim 9, wherein the first air guide elements and/or the second air guide elements comprise an adapter by way of which the first air guide elements and/or the second air guide elements of the at least two air vents are connectible with one another and/or with the coupling or the connecting shaft.

18. The arrangement according to claim 10, wherein the coupling or the connecting shaft is so constructed that the connection between the first air guide elements and/or the second air guide elements of the at least two air vents is separable.

19. The arrangement according to claim 10, wherein the first air guide elements and/or the second air guide elements comprise an adapter by way of which the first air guide elements and/or the second air guide elements of the at least two air vents are connectible with one another and/or with the coupling or the connecting shaft.

20. The arrangement according to claim 10, wherein the coupling or the connecting shaft is so constructed that the connection between the first air guide elements and/or the second air guide elements of the at least two air vents is separable.
